(19) United States
(12) Patent Application Publication
(10) Pub. No.: US 2019/0370681 A1
(43) Pub. Date: Dec. 5, 2019

(54) CLUSTERING METHOD, CLASSIFICATION METHOD, CLUSTERING APPARATUS, AND CLASSIFICATION APPARATUS

(71) Applicant: Panasonic Intellectual Property Corporation of America, Torrance, CA (US)

(72) Inventor: Tatsumi OBA, Osaka (JP)

(21) Appl. No.: 16/391,871

(22) Filed: Apr. 23, 2019

Related U.S. Application Data
(60) Provisional application No. 62/677,921, filed on May 30, 2018.

(30) Foreign Application Priority Data
Oct. 11, 2018 (JP) 2018-192601

(51) Int. Cl. G06N 20/00; H04L 29/06

(52) U.S. Cl. CPC G06N 20/00; H04L 69/326; H04L 69/22

(57) ABSTRACT

A clustering method for clustering packets is provided. The clustering method calculates similarities between packets, and clusters the packets using the calculated similarities.

### CROSS REFERENCE TO RELATED APPLICATION

This application claims the benefit of priority of Japanese Patent Application Number 2018-192601 filed on Oct. 11, 2018, and U.S. Provisional Patent Application No. 62/677,921 filed on May 30, 2018, the entire content of which is hereby incorporated by reference.

### BACKGROUND

### 1. Technical Field

The present disclosure relates to a clustering method which clusters packets.

### 2. Description of the Related Art

Conventional information processing techniques used in network systems and performed on data are known (see Ye, N. (2000, June). A Markov chain model of temporal behavior for anomaly detection. In Proceedings of the 2000 IEEE Systems, Man, and Cybernetics Information Assurance and Security Workshop (Vol. 166, p. 169). West Point, N.Y.; and Otey, M. E., Ghoting, A., & Parthasarathy, S. (2006). Fast distributed outlier detection in mixed-attribute data sets. Data mining and knowledge discovery, 12(2-3), 203-228, for example).

There is a desire for clustering of packets used in network systems.

Accordingly, an object of the present disclosure is to provide a method of clustering packets.

### SUMMARY

A clustering method according to one aspect of this disclosure calculates similarities between packets, and clusters the packets using the calculated similarities.

The classification method according to one aspect of this disclosure trains a machine learning model such that one packet is classified, using a result of clustering by the clustering method as a supervisor, and classifies one packet using the machine learning model which has already been trained.

The clustering apparatus according to one aspect of this disclosure includes a calculator which calculates similarities between packets, and a clusterer which clusters the packets using the similarities calculated by the calculator.

The classification apparatus according to one aspect of this disclosure includes a learner which trains a machine learning model such that one packet is classified, using a result of clustering by the clustering method as a supervisor, and a classifier which classifies one packet using the machine learning model which has already been trained.

The clustering method according to one aspect of this disclosure can cluster packets.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a block diagram illustrating a configuration of a clustering system according to Embodiment 1;

FIG. 2 illustrates one example of profile information stored in a profile determiner according to Embodiment 1;

FIG. 3 illustrates another example of profile information stored in the profile determiner according to Embodiment 1;

FIG. 4 is a schematic view illustrating a data structure of a packet in a TCP protocol;

FIG. 5 is a schematic view illustrating a data structure of a packet in a UDP protocol;

FIG. 6 is a schematic view illustrating a data structure of a packet in a Modbus/TCP protocol;

FIG. 7 is a schematic view illustrating one example of how a calculator according to Embodiment 1 cuts packet data in a unit of one byte;

FIG. 8 is a schematic view illustrating how the calculator according to Embodiment 1 calculates the Levenshtein distance between two character strings;

FIG. 9 is a schematic view illustrating how the calculator according to Embodiment 1 calculates the Levenshtein distance between two byte strings;

FIG. 10A is a schematic view illustrating a similarity matrix, where similarities between pieces of packet data before clustering are arranged into a matrix;

FIG. 10B is a schematic view illustrating a similarity matrix, where the similarities between pieces of packet data are arranged into a matrix in the state where the pieces of packet data after clustering are rearranged in each of the clusters obtained by clustering;

FIG. 11 is a schematic view illustrating how the classifier according to Embodiment 1 classifies a packet using a k-nearest neighbor algorithm where K is 1;

FIG. 12 is a flowchart of first clustering processing;

FIG. 13 is a flowchart of first learning processing;

FIG. 14 is a flowchart of first classification processing;

FIG. 15 is a block diagram illustrating a configuration of a clustering system according to Embodiment 2;

FIG. 16 is a flowchart of second clustering processing;

FIG. 17 is a flowchart of second learning processing;

FIG. 18 is a flowchart of second classification processing;

FIG. 19 is a block diagram illustrating a configuration of a clustering system according to Embodiment 3; and

FIG. 20 is a flowchart of third learning processing.

### DETAILED DESCRIPTION OF THE EMBODIMENTS

### How One Aspect of the Present Disclosure has been Achieved

In the related art, a dedicated parser for a protocol should be prepared to examine the type of a packet in the protocol, and a location representing the type of the packet should be obtained by the parser. In contrast, based on an idea that the clustering of packets is learned from a packet group and unknown packets are classified based on the results of learning, the present inventor has conceived a clustering method, a classification method, a clustering apparatus, and a classification apparatus according to one aspect of this disclosure, which will be described below.

The clustering method according to one aspect of this disclosure calculates similarities between packets, and clusters the packets using the calculated similarities.

In the calculating, the similarities may be calculated using Levenshtein distances between payloads in the packets.

In the clustering, the packets may be clustered using a spectral clustering method.

In the calculating, the similarities may be calculated using a string kernel defined between payloads in the packets, and in the clustering, the packets may be clustered using kernel K-means using the string kernel.

The clustering method can perform clustering of packets.

The classification method according to one aspect of this disclosure trains a machine learning model such that one packet is classified, using a result of clustering by the clustering method as a supervisor, and classifies one packet using the machine learning model which has already been trained.

In the training, a k-nearest neighbor algorithm may be used.

In the training, a support vector machine may be used.

In the training, a neural network may be used.

The classification method described above can classify one packet.

The clustering method according to one aspect of this disclosure includes a calculator which calculates similarities between packets, and a clusterer which clusters the packets using the similarities calculated by the calculator.

The clustering apparatus described above can cluster the packets.

The classification apparatus according to one aspect of this disclosure includes a learner which trains a machine learning model such that one packet is classified, using a result of clustering by the clustering method according to any one of Aspects 1 to 4 as a supervisor, and a classifier which classifies one packet using the machine learning model which has already been trained.

The classification apparatus described above can classify one packet.

Specific examples of the clustering method, the classification method, the clustering apparatus, and the classification apparatus according to one aspect of this disclosure will now be described with reference to the drawings. The embodiments described here all illustrate only specific examples of this disclosure. Accordingly, numeric values, shapes, components, arrangements of components, connection forms, steps, and order of steps illustrated in the following embodiments are only examples, and should not be construed as limitation to this disclosure. Among the components included in the following embodiments, those not described in independent claims are components which can be arbitrarily added. The drawings are schematic views, and are not always strictly drawn.

### EMBODIMENTS

### Embodiment 1

One example of a clustering system according to one aspect of this disclosure will now be described.

This clustering system clusters a packet group composed of packets. The clustering system also classifies unknown packets.

### 1-1. Configuration

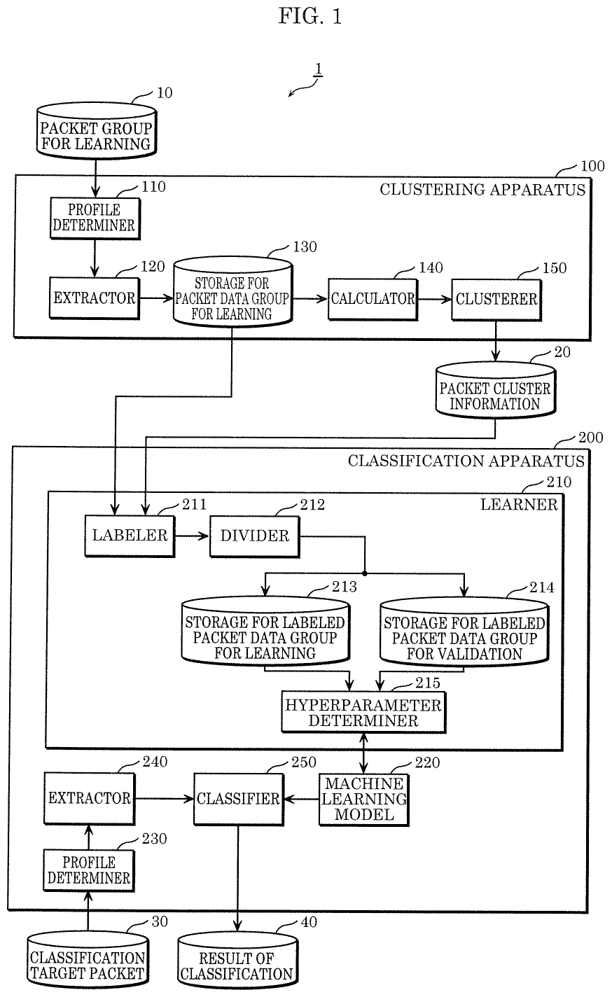

FIG. 1 is a block diagram illustrating a configuration of clustering system 1 according to Embodiment 1, which is one example of the clustering system according to one aspect of this disclosure.

As illustrated in FIG. 1, clustering system 1 includes clustering apparatus 100 and classification apparatus 200.

Clustering apparatus 100 obtains packet group 10 for learning composed of packets, and determines the profiles of packets in packet group 10. Clustering apparatus 100 then clusters the packets whose profiles are determined as identical. Clustering apparatus 100 outputs packet cluster information 20 as a result of clustering.

Clustering apparatus 100 is implemented with a computer apparatus including a memory and a processor which executes programs stored in the memory, for example. In this case, a variety of functions to be implemented by clustering apparatus 100 are implemented through execution of the programs, which are stored in the memory included in clustering apparatus 100, by the processor included in clustering apparatus 100.

Classification apparatus 200 trains machine learning model 220 (described later) using packet cluster information 20, which is output from clustering apparatus 100, as a supervisor. Using machine learning model 220 which has already been trained, classification apparatus 200 then classifies classification target packet 30, and outputs classification result 40.

Classification apparatus 200 is implemented with a computer apparatus including a memory and a processor which executes programs stored in the memory, for example. In this case, a variety of functions to be implemented by classification apparatus 200 are implemented through execution of the programs, which are stored in the memory included in classification apparatus 200, by the processor included in classification apparatus 200.

As illustrated in FIG. 1, clustering apparatus 100 further includes profile determiner 110, extractor 120, storage 130 for a packet data group for learning, calculator 140, and clusterer 150.

Profile determiner 110 obtains packet group 10 for learning. Profile determiner 110 then determines the profile corresponding to each of the packets included in the obtained packet group 10 for learning, based on its attribute information (such as a destination IP, a source IP, a destination port, a source port, and a protocol). Profile determiner 110 may store profile information, and based on the stored profile information, may determine the profile corresponding to each of the packets included in the obtained packet group 10 for learning, for example.

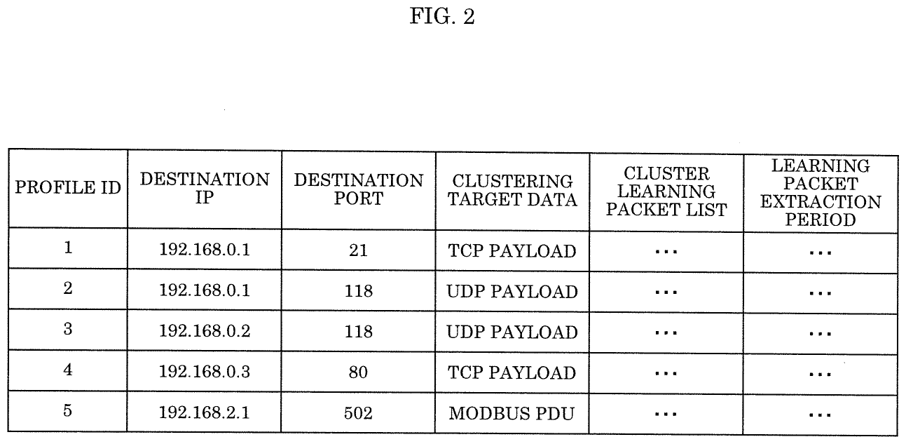

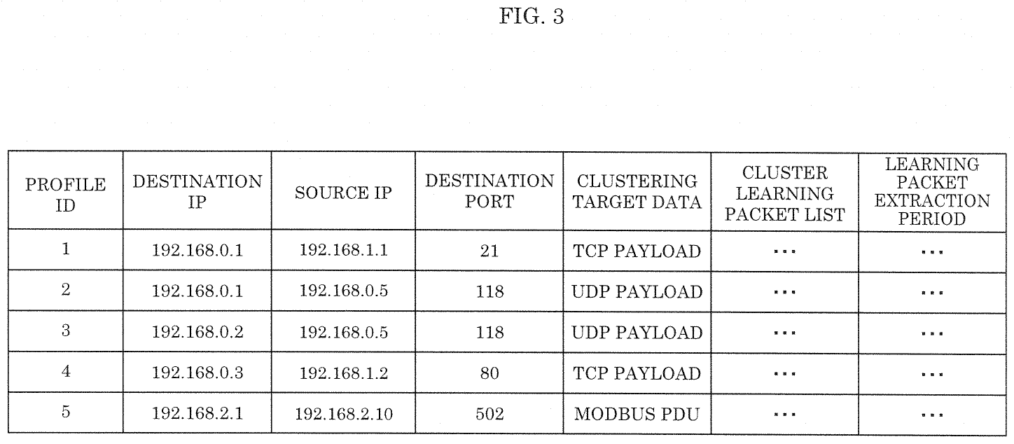

FIGS. 2 and 3 are examples of the profile information stored by profile determiner 110.

Profile determiner 110 stores the profile information illustrated in FIG. 2, and determines the profile of each packet, the profile being identified with the profile ID in the row which has a match with the combination of the destination IP and the destination port, for example. Alternatively, profile determiner 110 stores the profile information illustrated in FIG. 3, and determines the profile of each packet, the profile being identified with the profile ID in the row which has a match with the combination of the destination IP, the source IP, and the destination port, for example.

For example, in the case where the target packet for determination of the profile does not correspond to the profile information stored, profile determiner 110 may specify the protocol of the target packet by executing an application including a Deep Packet Inspection function, and may determine the profile of the packet based on the specified protocol.

Again returning to FIG. 1, clustering system 1 will be further described.

For the packets having the profiles determined by profile determiner 110, extractor 120 extracts the data stored in the payload field of each of the packets, as the packet data, for each profile. Extractor 120 then outputs a packet data group for learning composed of the extracted pieces of packet data.

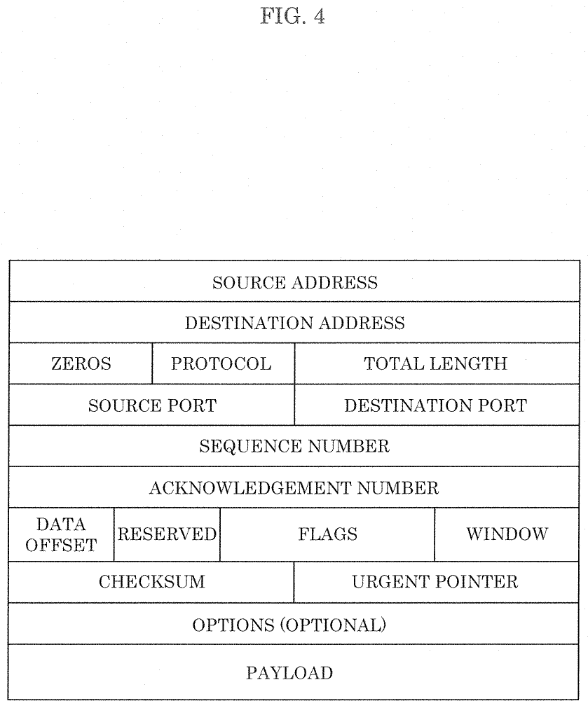

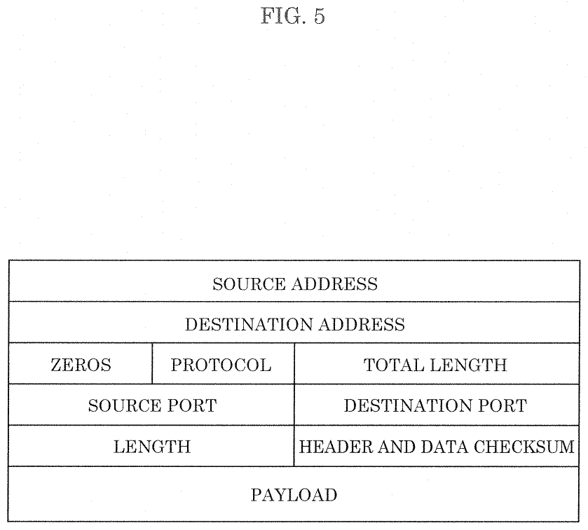

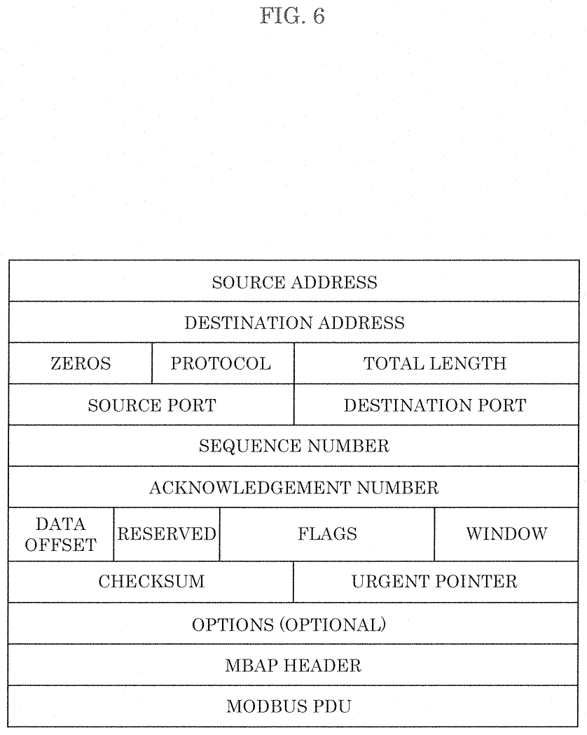

FIG. 4 is a schematic view illustrating a data structure of a packet in a TCP protocol. FIG. 5 is a schematic view illustrating a data structure of a packet in a UDP protocol. FIG. 6 is a schematic view illustrating a data structure of a packet in a Modbus/TCP protocol.

For example, in the case where the target packet is a packet in the TCP protocol, extractor 120 extracts the data stored in the Payload field (illustrated in FIG. 4) as the packet data. For example, in the case where the target packet is a packet in the UDP protocol, extractor 120 extracts the data stored in the Payload field (illustrated in FIG. 5) as the packet data. For example, in the case where the target protocol is a packet in the Modbus/TCP protocol, extractor 120 extracts the data stored in the Modbus PDU field (illustrated in FIG. 6) as the packet data.

Again returning to FIG. 1, clustering system 1 will be further described.

Storage 130 for a packet data group for learning stores the packet data group for learning output from extractor 120.

Storage 130 for a packet data group for learning is implemented as part of a storage region of the memory included in the clustering apparatus, for example.

Calculator 140 calculates the similarities among the pieces of packet data included in the packet data group for learning (hereinafter, also referred to as “packet data for learning”), which is stored in storage 130 for a packet data group for learning. At this time, calculator 140 calculates the similarities between pieces of packet data for each packet data group composed of pieces of packet data whose profiles are determined as identical.

Calculator 140 handles each piece of packet data as a byte string of the packet data cut in a unit of one byte, and calculates the similarities between pieces of packet data by calculating the similarities between the byte strings.

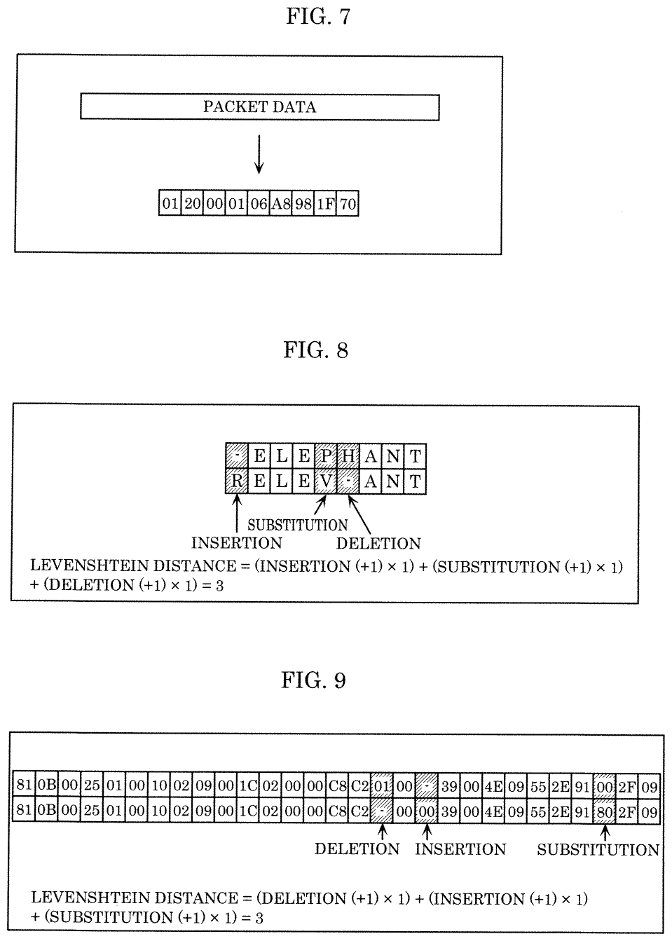

FIG. 7 is a schematic view illustrating one example of how calculator 140 cuts the packet data in a unit of one byte.

Although calculator 140 cuts the packet data in a unit of one byte in the description above, the packet data can be cut in a unit of any byte other than one byte. The unit for the cutting may be a bit string having any length in the range of 1 bit or more and 64 bits or less. This operation of calculator 140 should not be limited to examples in which the packet data is cut into continuous bit units. For example, calculator 140 may cut the packet data into bit strings by repetition of processing to cut x bits and skip y bits.

Again returning to FIG. 1, clustering system 1 will be further described.

Calculator 140 calculates the similarities using the Levenshtein distances between pieces of packet data.

The Levenshtein distance is a distance which can be defined between two character strings or byte strings. The Levenshtein distance is defined as a minimum number of times of insertion, deletion, and/or substitution of one character or byte needed to convert one character or byte string to the other character or byte string.

FIG. 8 is a schematic view illustrating how calculator 140 calculates the Levenshtein distance between two character strings (here, between character strings “ELEPHANT” and “RELEVANT” as one example).

As illustrated in FIG. 8, the minimum number of times of insertion, deletion, and/or substitution needed to convert “ELEPHANT” into “RELEVANT” is 3. For this reason, calculator 140 calculates the Levenshtein distance between “ELEPHANT” and “RELEVANT” as “3”.

FIG. 9 is a schematic view illustrating how calculator 140 calculates the Levenshtein distance between two byte strings.

As illustrated in FIG. 9, the minimum number of times of insertion, deletion, and/or substitution needed to convert one byte string into the other byte string is 3. For this reason, calculator 140 calculates the Levenshtein distance between the byte strings illustrated in FIG. 9 as “3”.

For example, calculator 140 calculates the similarity represented by (Expression 1):

sim(x, y)=1−dist(x, y)/max(length(x), length(y)) (Expression 1)

In (Expression 1), sim(x, y) is the similarity between a character or byte string x and a character or byte string y. dist(x, y) is the Levenshtein distance between the character or byte string x and the character or byte string y. length(x) is the length of the character or byte string x, and length(y) is the length of the character or byte string y. At this time, dist(x, y)/max(length(x), length(y)) is the Levenshtein distance normalized such that the distance is [0, 1].

Again returning to FIG. 1, clustering system 1 will be further described.

Clusterer 150 clusters the pieces of packet data using the similarities calculated by calculator 140. At this time, for each packet data group composed of pieces of packet data whose profiles are determined as identical, clusterer 150 clusters the pieces of packet data belonging to the packet data group into clusters, each of which is composed of pieces of packet data having relatively high similarities to each other. Clusterer 150 then outputs packet cluster information 20 indicating the result of clustering of the packet data. More specifically, clusterer 150 calculates a similarity matrix where the similarities among target pieces of packet data for clustering are arranged into a matrix, and clusters the target pieces of packet data by performing clustering by a spectral clustering method using the calculated similarity matrix as an input. For each target packet data for clustering, clusterer 150 then generates packet cluster information 20 to each packet data, packet cluster information 20 indicating the packet data in association with the cluster ID for specifying the cluster into which the data packet is clustered, and outputs packet cluster information 20.

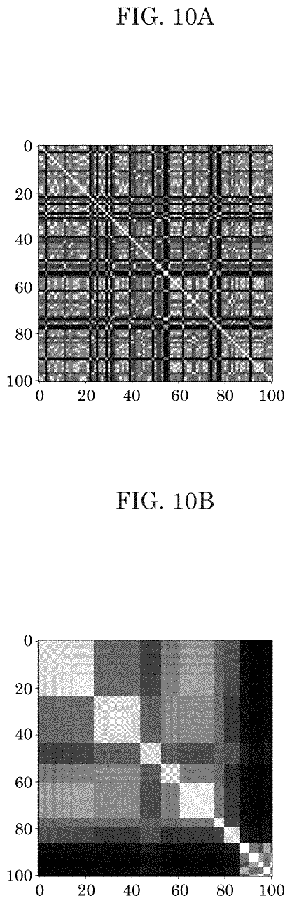

FIG. 10A is a schematic view illustrating a similarity matrix, where similarities between pieces of packet data before clustering by clusterer 150 are arranged into a matrix. FIG. 10B is a schematic view illustrating a similarity matrix, where the similarities between pieces of packet data are arranged into a matrix in the state where the pieces of packet data after clustering are rearranged in each of the clusters obtained as a result of clustering by clusterer 150. In FIGS. 10A and 10B, the point at a row i and a column j represents the similarity between packet data i and packet data j. Here, points having higher similarities have lighter representations while those having lower similarities have darker representations.

As illustrated in FIGS. 10A and 10B, using the spectral clustering method in which the calculated similarity matrix is used as an input, clusterer 150 can cluster pieces of packet data into clusters, each of which is composed of pieces of packet data having relatively high similarities to each other.

Clusterer 150 may eliminate the same packet data during clustering of packet data.

Again returning to FIG. 1, clustering system 1 will be further described.

As illustrated in FIG. 1, classification apparatus 200 further includes learner 210, machine learning model 220, profile determiner 230, extractor 240, and classifier 250.

Learner 210 trains machine learning model 220 such that one packet is classified, using packet cluster information 20, which is output from clustering apparatus 100, as a supervisor. More specifically, learner 210 trains machine learning model 220 such that from the packet data of one packet, the one packet is classified into any one of clusters, which are destinations of clustering by clustering apparatus 100. Learner 210 trains machine learning model 220 individually for each profile determined by profile determiner 110.

Here, learner 210 uses a k-nearest neighbor algorithm when learner 210 trains machine learning model 220. In other words, learner 210 trains machine learning model 220 such that one packet is classified, using the k-nearest neighbor algorithm.

As illustrated in FIG. 1, learner 210 further includes labeler 211, divider 212, storage 213 for a labeled packet data group for learning, storage 214 for a labeled packet data group for validation, and hyperparameter determiner 215.

Based on packet cluster information 20, labeler 211 labels a label for a supervisor to each packet data for learning stored in storage 130 for a packet data group for learning. More specifically, labeler 211 labels the cluster ID, as the label for a supervisor of the packet data for learning, to each piece of packet data for learning stored in storage 130 for a packet data group for learning, the cluster ID being associated with each piece of packet data for learning by packet cluster information 20.

For cross-validation, divider 212 divides the packet data for learning labeled by labeler 211 into a labeled packet data group for learning and a labeled packet data group for validation.

Storage 213 for a labeled packet data group for learning stores the labeled packet data group for learning obtained from the division by divider 212.

Storage 213 for a labeled packet data group for learning is implemented as part of the storage region of the memory included in classification apparatus 200, for example.

Storage 214 for a labeled packet data group for validation stores the labeled packet data group for validation obtained from the division by divider 212.

Storage 214 for a labeled packet data group for validation is implemented as part of the storage region of the memory included in classification apparatus 200, for example.

Hyperparameter determiner 215 determines the hyperparameter of machine learning model 220 by performing cross-validation using the labeled packet data group for learning stored in storage 213 for a labeled packet data group for learning and the labeled packet data group for validation stored in storage 214 for a labeled packet data group for validation. More specifically, hyperparameter determiner 215 determines the value of the hyperparameter (for example, the value of K) in the k-nearest neighbor algorithm used in machine learning model 220.

Machine learning model 220 is a machine learning model trained such that one packet is classified, using the k-nearest neighbor algorithm, where packet cluster information 20 output from clustering apparatus 100 is used as a supervisor. More specifically, machine learning model 220 is a machine learning model trained by learner 210 such that from the packet data of one packet, the one packet is classified into any one of clusters, which are destinations of clustering by clustering apparatus 100. Machine learning model 220 is a learning model individually trained for each profile determined by profile determiner 110.

Profile determiner 230 obtains classification target packet 30. Profile determiner 230 then determines the profile corresponding to the obtained classification target packet 30, based on the attribute information (such as a destination IP, a source IP, a destination port, a source port, and a protocol). Profile determiner 230 determines the profile in the same manner as in profile determiner 110.

Extractor 240 extracts the data stored in the payload field of the packet, as packet data, for the packet whose profile is determined by profile determiner 230.

Classifier 250 classifies classification target packet 30, which is one packet, using machine learning model 220 which has already been trained. At this time, classifier 250 uses machine learning model 220 according to the profile of classification target packet 30 determined by profile determiner 230.

Among the pieces of packet data for learning, classifier 250 first calculates K pieces of packet data for learning having the highest similarity from the pieces of packet data for learning whose profiles are determined as identical to the determined profile of classification target packet 30. In the next step, classifier 250 specifies the cluster to which the largest number of pieces of packet data in the calculated K pieces of packet data for learning is classified. Classifier 250 then classifies classification target packet 30 into the specified cluster.

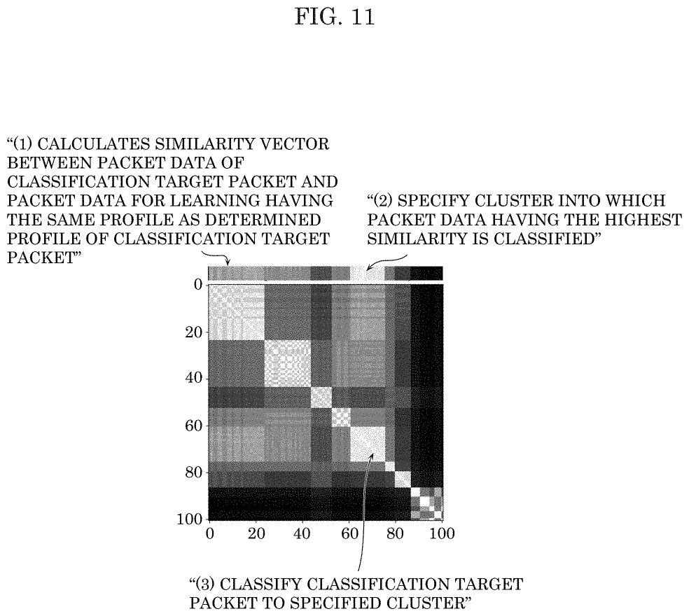

FIG. 11 is a schematic view illustrating how classifier 250 classifies a packet using a k-nearest neighbor algorithm where K is 1.

As illustrated in FIG. 11, classifier 250 (1) calculates the similarity vector of the packet data of classification target packet 30 and the packet data for learning having the same profile as the determined profile of classification target packet 30. In the next step, classifier 250 (2) specifies the cluster into which the pieces of packet data having the highest similarity is classified. Classifier 250 then (3) classifies classification target packet 30 into the specified cluster.

Again returning to FIG. 1, clustering system 1 will be further described.

After classifying classification target packet 30, classifier 250 outputs classification result 40 indicating the result of classification.

### 1-2. Operation

The operation of clustering system 1 having the configuration described above will now be described.

Clustering system 1 performs first clustering processing, first learning processing, and first classification processing. These processings will now be described in sequence with reference to the drawings.

The first clustering processing is processing to cluster packets. The first clustering processing is mainly performed by clustering apparatus 100. The first clustering processing is started, for example, by a user of clustering apparatus 100, who performs an operation to start the first clustering processing on clustering apparatus 100.

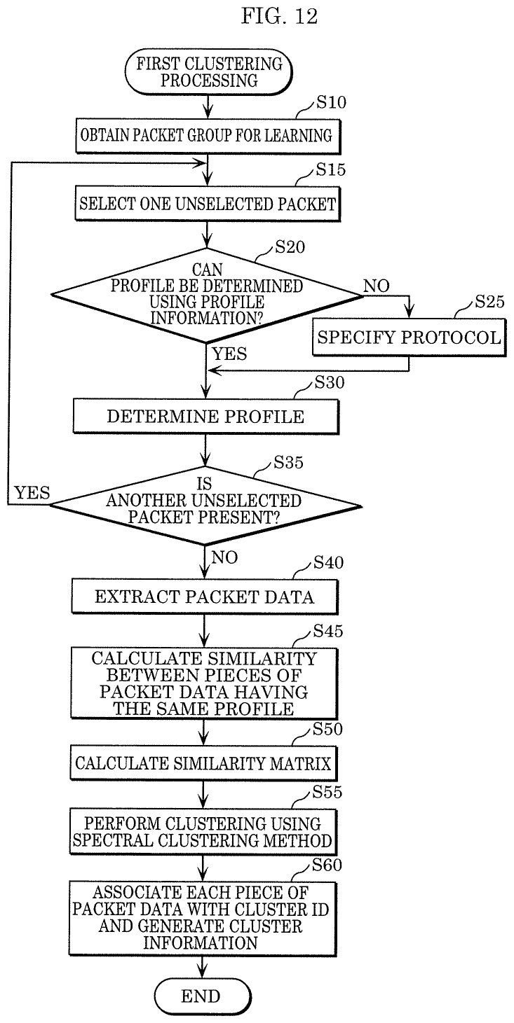

FIG. 12 is a flowchart of the first clustering processing.

When the first clustering processing is started, profile determiner 110 obtains packet group 10 for learning (step S10).

After obtaining packet group 10 for learning, profile determiner 110 selects one unselected packet from the packets included in packet group 10 for learning (step S15). Here, the unselected packet indicates a packet which has not been selected yet in the processing in step S15 in the loop processing formed from the processing in step S15 to the processing in step S35 (Yes) (described later).

After selecting one packet, profile determiner 110 checks whether the profile of the selected packet can be determined using the stored profile information (step S20).

In the case where the profile of the selected packet can be determined in the processing in step S20 using the stored profile information (Yes in step S20), profile determiner 110 determines the profile of the selected packet using the stored profile information (step S30).

In the case where the profile of the selected packet cannot be determined in the processing in step S20 using the stored profile information (No in step S20), profile determiner 110 specifies the protocol of the selected packet by executing an application including a Deep Packet Inspection function (step S25). Based on the specified protocol, profile determiner 110 then determines the profile of the selected packet (step S30).

After determining the profile of the selected packet, profile determiner 110 checks whether another unselected packet is present in the packets included in packet group 10 for learning (step S35).

In the case where another unselected packet is present in the processing in step S35 (Yes in step S35), clustering system 1 again goes to the processing in step S15.

In the case where such an unselected packet is not present in the processing in step S35 (No in step S35), as the packet data, extractor 120 extracts the data stored in the payload field of each of the packets for each profile for the packets having profiles determined by profile determiner 110 (step S40).

After the packet data is extracted, calculator 140 calculates the similarities between pieces of packet data having the same profile (step S45). At this time, calculator 140 calculates the Levenshtein distances between pieces of packet data as the similarities.

After the similarities between the pieces of packet data are calculated, clusterer 150 calculates a similarity matrix where the similarities between the pieces of packet data are arranged into a matrix (step S50). Clusterer 150 then clusters the pieces of packet data by the spectral clustering method using the calculated similarity matrix as an input (step S55). Clusterer 150 then generates packet cluster information 20 to each packet data, packet cluster information 20 indicating the packet data in association with the cluster ID for specifying the cluster into which the data packet is clustered (step S60).

At the end of the processing in step S60, clustering system 1 terminates the first clustering processing.

The first learning processing is processing to train machine learning model 220 using the results of clustering by clustering apparatus 100 as a supervisor. The first learning processing is mainly performed by classification apparatus 200. The first learning processing is started as follows, for example: After clustering apparatus 100 outputs packet cluster information 20, a user of classification apparatus 200 performs an operation to start the first learning processing on classification apparatus 200.

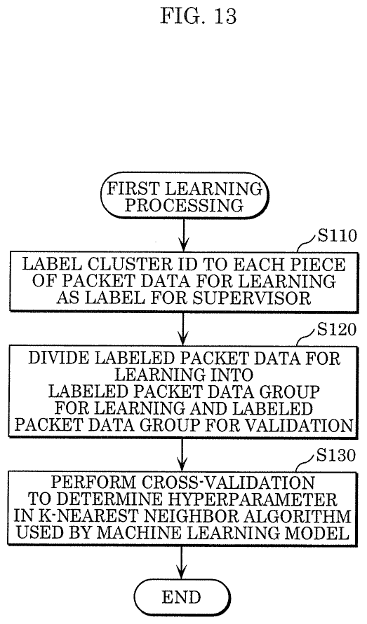

FIG. 13 is a flowchart of the first learning processing.

After the first learning processing is started, based on packet cluster information 20, labeler 211 labels the corresponding cluster ID as a label for a supervisor to each packet data for learning, which is stored in storage 130 for a packet data group for learning (step S110).

After the labeling, for cross-validation, divider 212 divides the packet data for learning labeled by labeler 211 into the labeled packet data group for learning and the labeled packet data group for validation (step S120).

After the division of the labeled packet data for learning, hyperparameter determiner 215 determines the value of the hyperparameter in the k-nearest neighbor algorithm used by machine learning model 220 by performing cross-validation using the labeled packet data group for learning and the labeled packet data group for validation (step S130).

At the end of the processing in step S130, clustering system 1 terminates the first learning processing.

The first classification processing is processing to classify one packet using machine learning model 220 which has already been trained. The first classification processing is mainly performed by classification apparatus 200. The first classification processing is started, for example, by a user of classification apparatus 200, who performs an operation to start the first classification processing on classification apparatus 200 in the state where machine learning model 220 has already been trained.

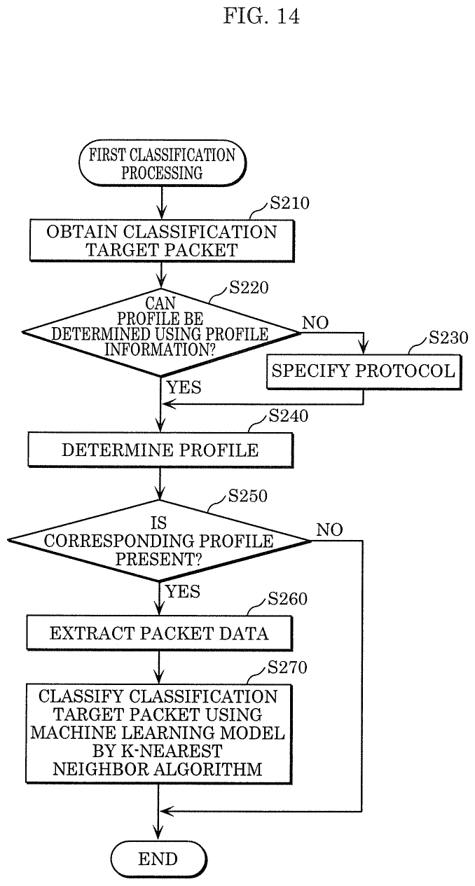

FIG. 14 is a flowchart of the first classification processing.

After the first classification processing is started, profile determiner 230 obtains classification target packet 30 (step S210).

Profile determiner 230 checks whether the profile of classification target packet 30 can be determined using the profile information stored when classification target packet 30 is obtained (step S220).

In the case where the profile of classification target packet 30 can be determined in the processing in step 820 using the stored profile information (Yes in step S220), profile determiner 110 determines profile of classification target packet 30 using the stored profile information (step S230).

In the case where the profile of classification target packet 30 cannot be determined in the processing in step S220 using the stored profile information (No in step S220), profile determiner 110 specifies the protocol of classification target packet 30 by executing an application including a Deep Packet Inspection function (step S230). Based on the specified protocol, profile determiner 230 then determines the profile of classification target packet 30 (step S240).

After determining the profile of classification target packet 30, profile determiner 230 checks whether the profile corresponding to the determined profile is present among the profiles determined to the packets included in packet group 10 for learning by profile determiner 110 (step S250).

In the case where the corresponding profile is present in the processing in step S250 (Yes in step S250), the data stored in the payload field is extracted as the packet data for classification target packet 30 (step S260).

After the packet data is extracted, classifier 250 classifies classification target packet 30 by the k-nearest neighbor algorithm using machine learning model 220 which has already been trained, and outputs classification result 40 indicating the result of classification (step S270).

In the case where the processing in step S270 is completed and the case where the corresponding profile is not present in the processing in step S250 (No in step S250), clustering system 1 terminates the first classification processing.

### 1-3. Discussion

As described above, clustering system 1 can cluster the packet group composed of packets. Clustering system 1 can also classify unknown packets.

### Embodiment 2

A clustering system according to Embodiment 2, which has a partially modified configuration of clustering system 1 according to Embodiment 1, will now be described.

Clustering system 1 according to Embodiment 1 has an exemplary configuration in which the Levenshtein distance between two pieces of packet data is calculated as a similarity, and the packet data is clustered using the spectral clustering method. In contrast, the clustering system according to Embodiment 2 has an exemplary configuration in which the similarities are calculated using the string kernel defined between pieces of packet data, and pieces of packet data are clustered using the kernel K-means using the string kernel. Clustering system 1 according to Embodiment 1 has an exemplary configuration in which the k-nearest neighbor algorithm is used when machine learning model 220 is trained. In other words, in the configuration of this example, machine learning model 220 is a learning model trained such that one packet is classified, using the k-nearest neighbor algorithm. In contrast, the clustering system according to Embodiment 2 has an exemplary configuration in which the support vector machine is used in the training of the machine learning model. In other words, in the configuration of this example, the machine learning model is a learning model trained such that one packet is classified, using the support vector machine.

Details of the clustering system according to Embodiment 2, mainly differences from clustering system 1 according to Embodiment 1 will now be described with reference to the drawings.

### 2-1. Configuration

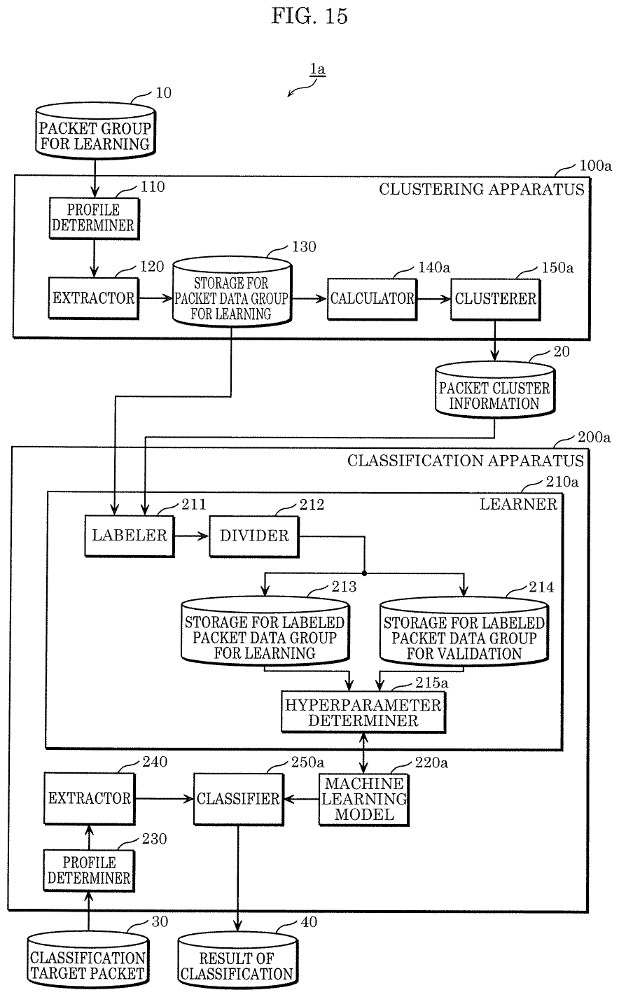

FIG. 15 is a block diagram illustrating a configuration of clustering system 1a according to Embodiment 2.

As illustrated in FIG. 15, clustering system 1a includes calculator 140a, clusterer 150a, learner 210a, hyperparameter determiner 215a, machine learning model 220a, and classifier 250a, rather than calculator 140, clusterer 150, learner 210, hyperparameter determiner 215, machine learning model 220, and classifier 250 included in clustering system 1 according to Embodiment 1.

Accompanied by these modifications, clustering apparatus 100 in clustering system 1 according to Embodiment 1 is replaced with clustering apparatus 100a, and classification apparatus 200 is replaced with classification apparatus 200a.

Calculator 140a calculates the similarities between pieces of packet data for learning included in a packet data group for learning stored in storage 130 for a packet data group for learning. At this time, as in calculator 140 according to Embodiment 1, calculator 140a calculates the similarities between pieces of packet data for each packet data group, which is composed of pieces of packet data whose profiles are determined as identical.

Calculator 140 according to Embodiment 1 calculates the Levenshtein distances between pieces of packet data as similarities. In contrast, calculator 140a is modified so at to calculate the string kernel defined between pieces of packet data, and calculate similarities using the calculated string kernel.

Clusterer 150a clusters the packet data using the similarities calculated by calculator 140a. At this time, as in clusterer 150 according to Embodiment 1, for each packet data group composed of pieces of packet data whose profiles are determined as identical, clusterer 150a clusters the pieces of packet data belonging to the packet data group into clusters, each of which is composed of pieces of packet data having relatively high similarities to each other. As in clusterer 150 according to Embodiment 1, clusterer 150a then outputs packet cluster information 20 indicating the result of clustering of packet data.

Clusterer 150 according to Embodiment 1 clusters the pieces of packet data by the spectral clustering method. In contrast, clusterer 150a is modified such that the pieces of packet data are clustered by performing clustering using the kernel K-means using the string kernel.

Learner 210a trains machine learning model 220a such that one packet is classified, using packet cluster information 20, which is output from clustering apparatus 100a, as a supervisor. More specifically, as in learner 210 according to Embodiment 1, learner 210a trains machine learning model 220a such that from the packet data of one packet, the one packet is classified into any one of clusters, which are destinations of clustering by clustering apparatus 100a. As in learner 210 according to Embodiment 1, learner 210a trains machine learning model 220a individually for each profile determined by profile determiner 110.

The k-nearest neighbor algorithm is used when learner 210 according to Embodiment 1 trains machine learning model 220. In other words, learner 210 according to Embodiment 1 trains machine learning model 220 such that one packet is classified, using the k-nearest neighbor algorithm. In contrast, the support vector machine is used when learner 210a trains machine learning model 220a. In other words, learner 210a is modified such that learner 210a trains machine learning model 220a such that one packet is classified, using the support vector machine.

Hyperparameter determiner 215a determines the hyperparameter of machine learning model 220a by performing cross-validation using a labeled packet data group for learning stored in storage 213 for a labeled packet data group for learning and a labeled packet data group for validation stored in storage 214 for a labeled packet data group for validation.

Hyperparameter determiner 215 according to Embodiment 1 determines the value of hyperparameter in the k-nearest neighbor algorithm used by machine learning model 220. In contrast, hyperparameter determiner 215a is modified such that the value of the hyperparameter in the support vector machine used by machine learning model 220a is determined.

Machine learning model 220a is a machine learning model trained by learner 210a such that from the packet data of one packet, the one packet is classified into any one of clusters, which are destinations of clustering by clustering apparatus 100a. As in machine learning model 220 according to Embodiment 1, machine learning model 220a is a learning model individually trained for each profile determined by profile determiner 110.

Machine learning model 220 according to Embodiment 1 is a machine learning model trained such that one packet is classified, using the k-nearest neighbor algorithm. In contrast, machine learning model 220a is a modified machine learning model trained such that one packet is classified, using the support vector machine.

Classifier 250a classifies classification target packet 30, which is one packet, using machine learning model 220a which has already been trained. At this time, as in classifier 250 according to Embodiment 1, classifier 250a uses machine learning model 220a according to the profile of classification target packet 30 determined by profile determiner 230.

Classifier 250 according to Embodiment 1 classifies one packet using the k-nearest neighbor algorithm. In contrast, classifier 250a is modified such that one packet is classified using the support vector machine.

### 2-2. Operation

The operation of clustering system 1a having the configuration described above will now be described.

Clustering system 1 performs second clustering processing which is a partial modification of the first clustering processing according to Embodiment 1, second learning processing which is a partial modification of the first learning processing according to Embodiment 1, and second classification processing which is a partial modification of the first classification processing according to Embodiment 1. These processings will now be described in sequence with reference to the drawings.

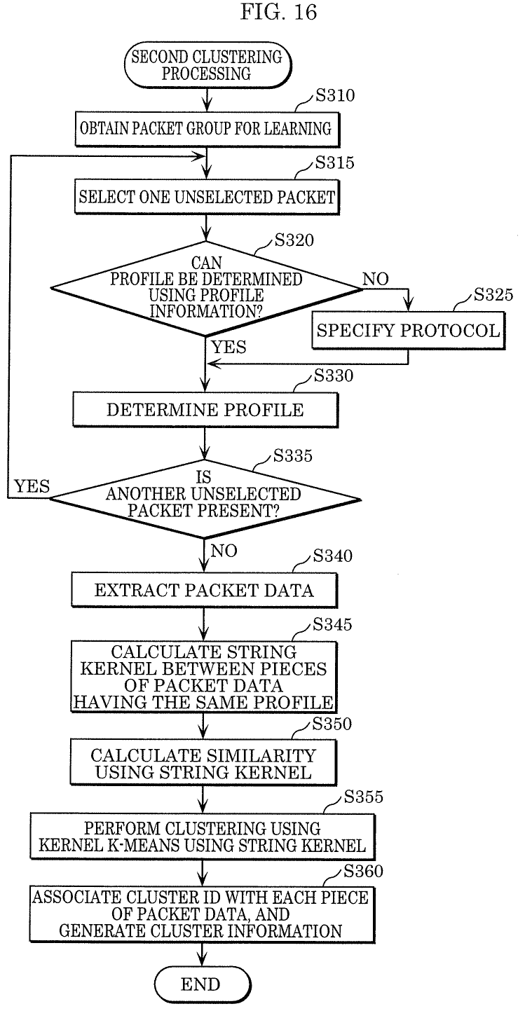

FIG. 16 is a flowchart of the second clustering processing.

The processing in step S310 to the processing in step S340 and the processing in step S360 in the second clustering processing correspond to and are identical to the processing in step S10 to the processing in step S40 and the processing in step S60 in first clustering processing according to Embodiment 1, respectively, where calculator 140 is replaced with calculator 140a and clusterer 150 is replaced with clusterer 150a. For this reason, the processing in step S310 to the processing in step S340 and the processing in step S360 have already been described, and their descriptions will be omitted here.

After the packet data is extracted in the processing in step S340, calculator 140a calculates the string kernel between pieces of packet data having the same profile (step S345). Calculator 140a then calculates similarities using the calculated string kernel (step S350).

After the similarities of pieces of packet data are calculated, clusterer 150a clusters the pieces of packet data by clustering using the kernel K-means using the string kernel (step S355).

At the end of the processing in step S355, clustering system 1a goes to the processing in step S360.

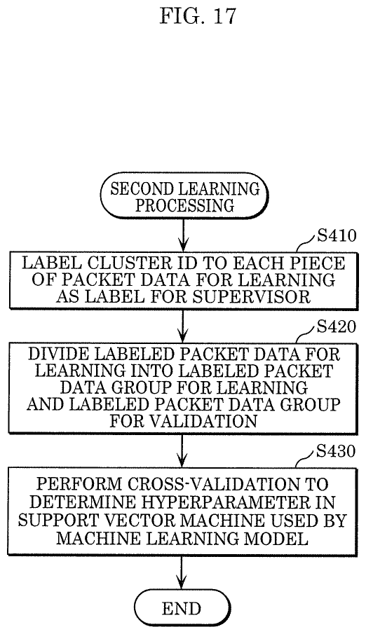

FIG. 17 is a flowchart of the second learning processing.

The processing in step S410 and the processing in step S420 in the second learning processing are the same as the processing in step S110 and the processing in step S120 in in the first learning processing according to Embodiment 1, respectively. For this reason, the processing in step S410 and the processing in step S420 have already been described, and their descriptions will be omitted here.

After the labeled packet data for learning is divided in the processing in step S420, hyperparameter determiner 215a determines the value of the hyperparameter in the support vector machine used by machine learning model 220a by performing cross-validation using the labeled packet data group for learning and the labeled packet data group for validation (step S430).

At the end of the processing in step S430, clustering system 1a terminates the second learning processing.

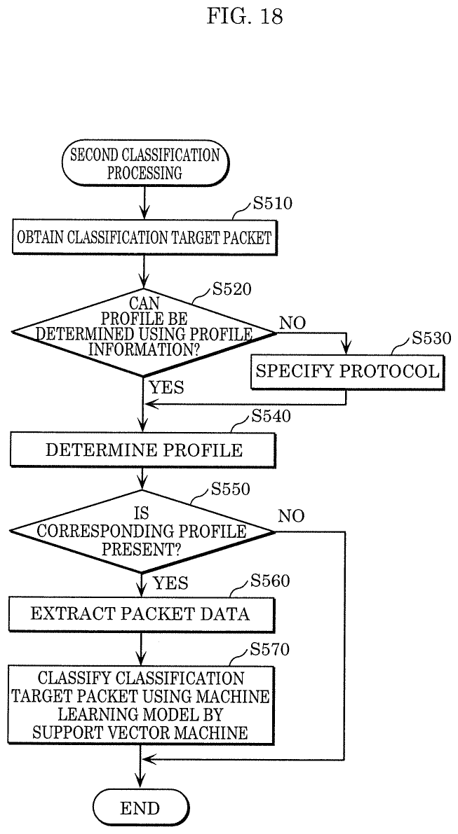

FIG. 18 is a flowchart of the second classification processing.

The processing in step S510 to processing in step S560 in the second classification processing are the same as the processing in step S210 to processing in step S260 in the first classification processing according to Embodiment 1, respectively. For this reason, the processing in step S510 to the processing in step S560 have already been described, and their descriptions will be omitted here.

After the packet data is extracted in the processing in step S560, classifier 250a classifies classification target packet 30 by the support vector machine using machine learning model 220a which has already been trained, and outputs classification result 40 indicating the result of classification (step S570).

In the case where the processing in step S570 is completed and the case where the corresponding profile is not present in the processing in step S550 (No in step S550), clustering system 1a terminates the second classification processing.

### 2-3. Discussion

As described above, clustering system 1a can cluster packets as in clustering system 1 according to Embodiment 1.

### Embodiment 3

A clustering system according to Embodiment 3, which has a partial modified configuration of clustering system 1 according to Embodiment 1, will now be described.

Clustering system 1 according to Embodiment 1 has an exemplary configuration in which the hyperparameter of machine learning model 220 is determined in the training of machine learning model 220. In contrast, the clustering system according to Embodiment 3 has an exemplary configuration in which the hyperparameter of the machine learning model is not determined in the training of the machine learning model.

Details of the clustering system according to Embodiment 3, mainly differences from clustering system 1 according to Embodiment 1 will now be described with reference to the drawings.

### 3-1. Configuration

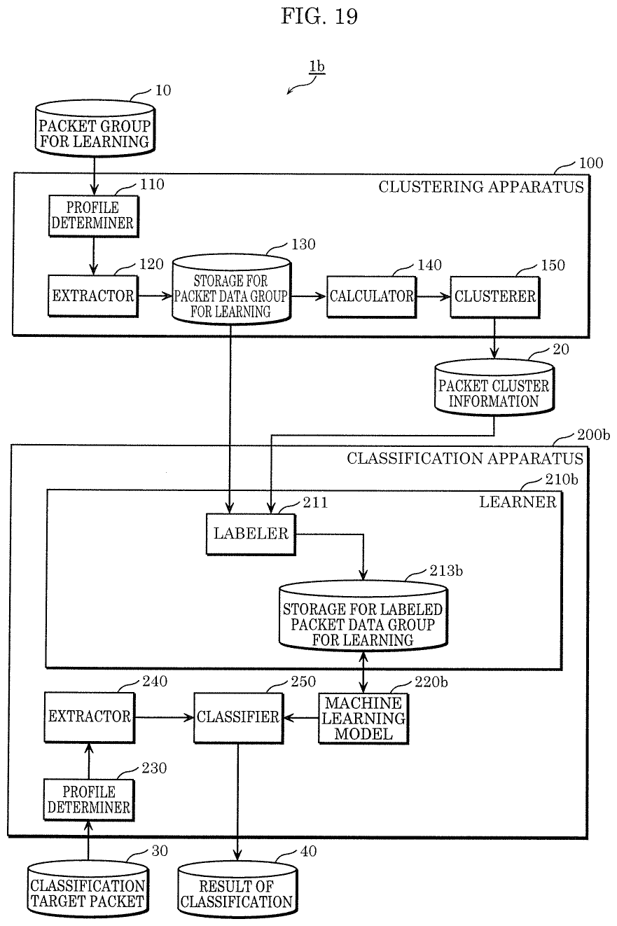

FIG. 19 is a block diagram illustrating a configuration of clustering system 1b according to Embodiment 3.

As illustrated in FIG. 19, clustering system 1b has a configuration different from that of clustering system 1 according to Embodiment 1 in that divider 212, storage 214 for a labeled packet data group for validation, and hyperparameter determiner 215 are eliminated, learner 210 is replaced with learner 210b, storage 213 for a labeled packet data group for learning is replaced with storage 213b for a labeled packet data group for learning, and machine learning model 220 is replaced with machine learning model 220b.

Accompanied by these modifications, classification apparatus 200 in clustering system 1 according to Embodiment 1 is replaced with classification apparatus 200b.

Learner 210b trains machine learning model 220b using packet cluster information 20, which is output from clustering apparatus 100a, as a supervisor such that one packet is classified. More specifically, as in learner 210 according to Embodiment 1, learner 210b trains machine learning model 220b such that from the packet data of one packet, the one packet is classified into any one of clusters, which are destinations of clustering by clustering apparatus 100. As in learner 210 according to Embodiment 1, learner 210b trains machine learning model 220b individually for each profile determined by profile determiner 110. As in learner 210 according to Embodiment 1, learner 210b uses the k-nearest neighbor algorithm when machine learning model 220b is trained. In other words, learner 210b trains machine learning model 220b such that one packet is classified, using the k-nearest neighbor algorithm.

Learner 210 according to Embodiment 1 determines the hyperparameter of machine learning model 220 when learners 210 trains machine learning model 220. In contrast, learner 210b is modified such that the hyperparameter of machine learning model 220b is not determined when learner 210b trains machine learning model 220b.

Storage 213b for a labeled packet data group for learning stores a labeled packet data group for learning labeled by labeler 211.

Machine learning model 220b is a machine learning model trained using the k-nearest neighbor algorithm such that one packet is classified, where packet cluster information 20 output from clustering apparatus 100 is used as a supervisor. As in machine learning model 220 according to Embodiment 1, machine learning model 220b is a machine learning model trained by learner 210b such that from the packet data of one packet, the one packet is classified into any one of clusters, which are destinations of clustering by clustering apparatus 100. As in machine learning model 220 according to Embodiment 1, machine learning model 220b is a learning model individually trained for each profile determined by profile determiner 110.

Machine learning model 220 according to Embodiment 1 is a machine learning model where the value of the hyperparameter in the k-nearest neighbor algorithm is determined by learner 210. In contrast, machine learning model 220b is a modified machine learning model such that the value of the hyperparameter by the k-nearest neighbor algorithm is not determined by learner 210.

### 3-2. Operation

An operation of clustering system 1b having the configuration described above will now be described.

Clustering system 1 performs the first clustering processing, third learning processing which is a partial modification of the first learning processing according to Embodiment 1, and the first classification processing. The third learning processing will now be described in sequence with reference to the drawing.

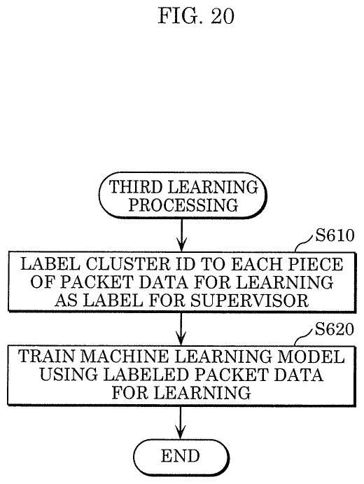

FIG. 20 is a flowchart of the third learning processing.

The processing in step S610 in the third learning processing is the same as the processing in step S110 in the first learning processing according to Embodiment 1. For this reason, the processing in step S610 has already been described, and its description will be omitted here.

After the labeling in the processing in step S610, machine learning model 220b is trained such that one packet is classified, using the k-nearest neighbor algorithm, where the packet data for learning labeled by labeler 211 is used (step S620).

At the end of the processing in step S620, clustering system 1b terminates the third learning processing.

### 3-3. Discussion

As described above, as in clustering system 1 according to Embodiment 1, clustering system 1b can cluster packets.

### Additional Remarks

As above, Embodiments 1 to 3 have been described as examples of the techniques disclosed in this application. However, the techniques according to this disclosure are not limited to these, and are also applicable to embodiments subjected to appropriate modification, substitution, addition, and elimination.

Examples of modifications in this disclosure will be listed below.

(1) In Embodiment 1, clustering system 1 has an exemplary configuration in which the similarity is calculated using the Levenshtein distance. In Embodiment 2, clustering system 1a has an exemplary configuration in which the similarity is calculated using the string kernel. The calculation of the similarity, however, may be performed by any other method than the methods described in Embodiments 1 and 2. The clustering system according to this disclosure may have a configuration in which the similarity is calculated using a normalized Levenshtein distance, a sequence alignment kernel, a spectrum kernel, a gap-weighted string kernel, or a mismatch string kernel, for example.

(2) In Embodiment 1, clustering system 1 has an exemplary configuration in which the packet data is clustered using the spectral clustering method. In Embodiment 2, clustering system 1a has an exemplary configuration in which the packet data is clustered using the kernel K-means. The clustering of the packet data, however, may be performed by any other method than the methods described in Embodiments 1 and 2. The clustering system according to this disclosure may have a configuration in which the packet data is clustered, for example, using graph-cut other than the spectral clustering method and the kernel K-means.

(3) In Embodiments 1 and 3, clustering system 1 and clustering system 1b each have an exemplary configuration in which machine learning model 220 or machine learning model 220a is trained such that one packet is classified, using the k-nearest neighbor algorithm, where packet cluster information 20 is used as a supervisor. In Embodiment 2, clustering system 1a has an exemplary configuration in which machine learning model 220b is trained such that one packet is classified, using the support vector machine, where packet cluster information 20 is used as a supervisor. However, the learning of the machine learning model may be performed by any other method than the methods described in Embodiments 1, 2, and 3. The clustering system according to this disclosure may have a configuration in which the machine learning model is trained by another supervised learning method such that one packet is classified. For example, the clustering system according to this disclosure may have a configuration in which the machine learning model is trained such that one packet is classified, using a neural network, where packet cluster information 20 is used as a supervisor. In this case, neural network techniques such as a convolutional neural network or a long short-term memory (LSTM) can be used to implement such a configuration.

(4) In Embodiment 1, the components in clustering system 1 may be formed as individual chips with semiconductor devices such as integrated circuits (ICs) or large scale integrations (LSIs), or may be partially or totally formed as a single chip. The components may be formed into (an) integrated circuit(s) by any other method than LSI, and may be implemented with a dedicated circuit or a general purpose processor. Field programmable gate arrays (FPGAs) which can be programed after manufacturing of LSIs and reconfigurable processors where connections and settings of circuit cells within LSIs can be reconfigured may also be used. Furthermore, integration of function blocks may be performed using any other emerging techniques for forming integrated circuits which can substitute LSI, those techniques being provided by the progress in the semiconductor techniques or other derived techniques. Application of bio techniques is one of possibilities, for example.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

This disclosure can be widely used in systems using packets.

What is claimed is:

1. A clustering method, comprising:
calculating similarities between packets; and
clustering the packets using the similarities calculated.

2. The clustering method according to claim 1,
wherein in the calculating, the similarities are calculated using Levenshtein distances between payloads of the packets.

3. The clustering method according to claim 1,
wherein in the clustering, the packets are clustered using a spectral clustering method.

4. The clustering method according to claim 1,
wherein in the calculating, the similarities are calculated using a string kernel defined between payloads of the packets, and
in the clustering, the packets are clustered using kernel K-means using the string kernel.

5. A classification method, comprising:
training a machine learning model such that one packet is classified, using a result of clustering by the clustering method according to claim 1 as a supervisor; and
classifying one packet using the machine learning model which has already been trained.

6. The classification method according to claim 5,
wherein in the training, a k-nearest neighbor algorithm is used.

7. The classification method according to claim 5,
wherein in the training, a support vector machine is used.

8. The classification method according to claim 5,
wherein in the training, a neural network is used.

9. A clustering apparatus, comprising:
a calculator which calculates similarities between packets; and
a clusterer which clusters the packets using the similarities calculated by the calculator.

10. A classification apparatus, comprising:
a learner which trains a machine learning model such that one packet is classified, using a result of clustering by the clustering method according to claim 1 as a supervisor; and
a classifier which classifies one packet using the machine learning model which has already been trained.
